(19) United States
(12) Patent Application Publication
(10) Pub. No.: US 2006/0007174 A1
(43) Pub. Date: Jan. 12, 2006

(54) Touch control method for a drag gesture and control module thereof

(76) Inventor: Chung-Yi Shen, Taipei (TW)

Correspondence Address: G'LINK COMPANY;Suite 137, PmB 174, 931 West 75th Street, Naperville, IL, 60565, US

(21) Appl. No.: 10/883,680

(22) Filed: Jul. 6, 2004

(51) Int. Cl. G09G 5/00

(52) U.S. Cl. 345/173

(57) ABSTRACT

A touch control method for a drag gesture, which identifies a motion of the drag gesture executed on the touch device by an object by way of a control module of the touch device with control signal being generated corresponding to the drag gesture for being used by an main unit as subsequent control function with a first reference time being defined in the control module, includes detecting occurrence of the drag generated during the object moving on the touch device and starting counting time at the same time; determining time of the object staying on the touch device; outputting a control signal representing the motion of drag gesture for being used by the main unit in case of the staying time being exceeding the first reference time and the object keeping moving a small distance on the touch device; and keeping outputting the control signal to the main unit during the object stopping moving and keeping contacting with the touch device and stopping outputting the control signal to the main unit once the object detaches from the touch device.

### BACKGROUND OF THE INVENTION

1. Field of the Invention

The present invention relates to a touch control method and control module thereof and particularly to a touch control method for a gesture of drag and the control module thereof with which control signal can be output continuously even in a state of stopping motion of the drag to allow the user operating with less effort.

2. Brief Description of Related Art

The software set up in the current computer mostly presents the window page thereof by way of Graphical User Interface (GUI) and the advantage of GUI resides in that a pointer on the screen can be operated by way of an auxiliary pointing tool such as a mouse device or a trackball moving on a flat surface. Using GUI is an operation method complying with human's visual sense so that it is a simple way widely utilized by various electronic products with the window page.

Taking the mouse as an example for describing function of the pointing tool, the pointer can move along with the mouse during being used and once the pointer on the window page is moved to a position, which is a button or a scroll bar ready to be scrolled, and a key of the mouse is pressed at the same time to perform an ordered instruction. Usually, the left key of the mouse is a system default key so that a function of the button can be executed or the scroll bar can be wound in case of the left key being pressed continuously to act a motion of double clicking or drag.

In addition to the pointing tools such as the mouse device and the trackball, a similar way such as using a touch pad or a touch panel with screen is also adopted instead. Due to the electronic product being developed with a trend of getting smaller, shorter, lighter and thinner and an approach of the laptop computer being used instead of the desktop computer gradually, it allows small sized touch pad or touch panel, which is possible to be associated with the electronic product, to increase applicable extent thereof relatively.

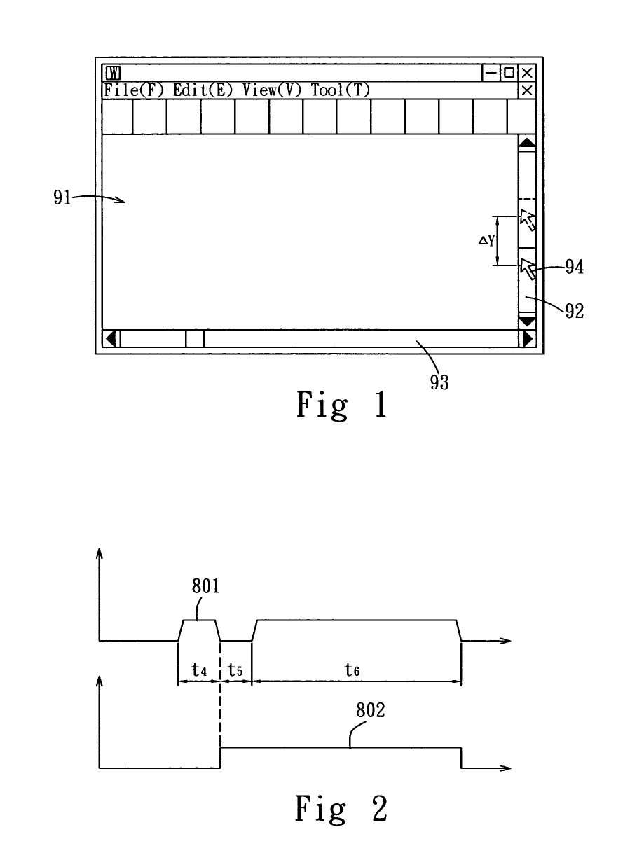

Referring to FIG. 1, taking an ordinary window page 91 being opened for an article reading as an example, a first scroll bar 92 is located at a lateral side thereof along the Y-axis direction and a second scroll bar 93 is located at the lower side thereof along the X-axis direction. When the article has a long content, the user can touch the touch device (not shown) with a finger or another object or drag a distance on the touch device to drive the pointer 94 scrolling the first and the second scroll bar 92, 93 so that the article in the window page 91 can move upward, downward, leftward and rightward during being read without being restricted by the size of the window page 91.

Referring to FIG. 2, U.S. Pat. No. 6,414,671 disclosed a recognition method of drag gesture on the known touch device. Firstly, the staying time duration t₄ of the first occurrence touch signal 801 during the object being on the touch device is compared to a reference time value and a control signal 802 is generated in case of the staying time duration t₄ is less than the reference time value. Then, a time span t₅ between the first occurrence touch signal and the second occurrence touch signal 801 is compared to a second reference time value and the control signal 802 is kept outputting in case of the time span t₅ is less than the second reference time value. Further, X, Y position data of the object on the touch device is detected and output within the staying time duration t₆ of the second occurrence.

Referring to FIG. 1 in company with FIG. 2, taking the first scroll bar 92 of the window page 91 being scrolled a distance ΔY as an example, it is necessary for the user to drag a distance continuously with the finger or another object and a touch signal 801 is generated corresponding to the drag gesture. The control signal 802 is generated after a time duration t₄ of the touch signal 801 initiating and the Y position data is detected and output within the staying time duration t₆ of the second occurrence.

However, the disadvantage of the preceding touch control method of drag gesture resides in that the way to decide the scrolling distance ΔY of the first scroll bar 92 is based on total moving amount of the Y position data corresponding to the drag gesture. If the user wants to scroll longer distance, it is necessary for the user to move the drag gesture a considerable distance on the touch device. Otherwise, the drag gesture has to be done repeatedly back and forth. But, repeated drag gesture is quite time consuming and needs great effort and it is very easy to result in fatigue while in use.

### SUMMARY OF THE INVENTION

Accordingly, an object of the present invention is to provide a touch control method for a gesture of drag with which control signal can be output continuously to allow the window page scrolling unceasingly even the finger or another object staying on the touch device after the drag gesture being done and the window page can stop scrolling at the time of the finger or another object not touching the touch device any more with facility for the user.

A touch control method for a gesture of drag according to the present invention identifies a motion of the drag gesture executed on the touch device by an object by way of a control module of the touch device with control signal being generated corresponding to the drag gesture for being used by an main unit as subsequent control function with a first reference time being defined in the control module.

The touch control method for a gesture of drag according to the present invention is detecting occurrence of the drag generated during the object moving on the touch device and starting counting time at the same time; determining time of the object staying on the touch device; outputting a control signal representing the gesture of drag for being used by the main unit in case of the staying time being exceeding the first reference time and the object keeping moving a small distance on the touch device; and keeping outputting the control signal to the main unit during the object stopping moving and keeping contacting with the touch device and stopping outputting the control signal to the main unit once the object detaches from the touch device.

A control module according to the present invention is to identify a gesture of drag executed on a touch device by an object with control signal being generated corresponding to the drag gesture for being used by an main unit as subsequent control function with a first reference time is defined in the control module. The control module includes an operation unit and a gesture unit connecting with the operation unit and the main unit.

The operation unit generates a touch signal corresponding to every occurrence of the object being on the touch device and the touch signal being generated at initiation of the occurrence and terminated at end of the occurrence. The gesture unit is for receiving the touch signal and figuring out time duration of the occurrence for identifying what motion of the object is.

The gesture unit determines time of the object staying on the touch device being exceeding the first reference time and outputs a control signal representing the motion of drag for being used by the main unit; and keeping outputting the control signal to the main unit during the object stopping moving and keeping contacting with the touch device and stopping outputting the control signal to the main unit once the object detaches from the touch device.

### BRIEF DESCRIPTION OF THE DRAWIGS

The detail structure, the applied principle, the function and the effectiveness of the present invention can be more fully understood with reference to the following description and accompanying drawings, in which:

FIG. 1 is a plan view illustrating a conventional window page for actuating the pointer to move position of the first scroll bar so as to scroll the scroll bar;

FIG. 2 is a wave curve illustrating a method of identifying a drag gesture executing on a conventional touch control device;

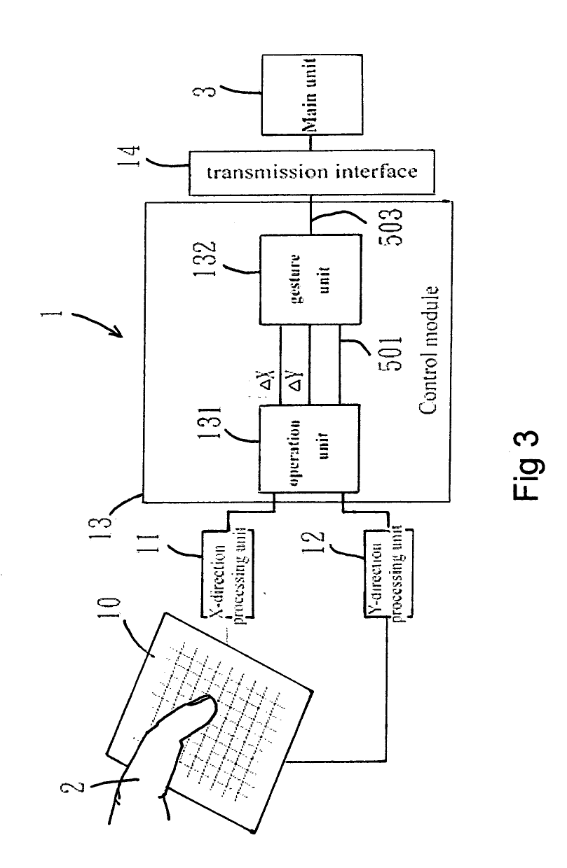

FIG. 3 is a block diagram illustrating a preferred embodiment of the control module according to the present invention;

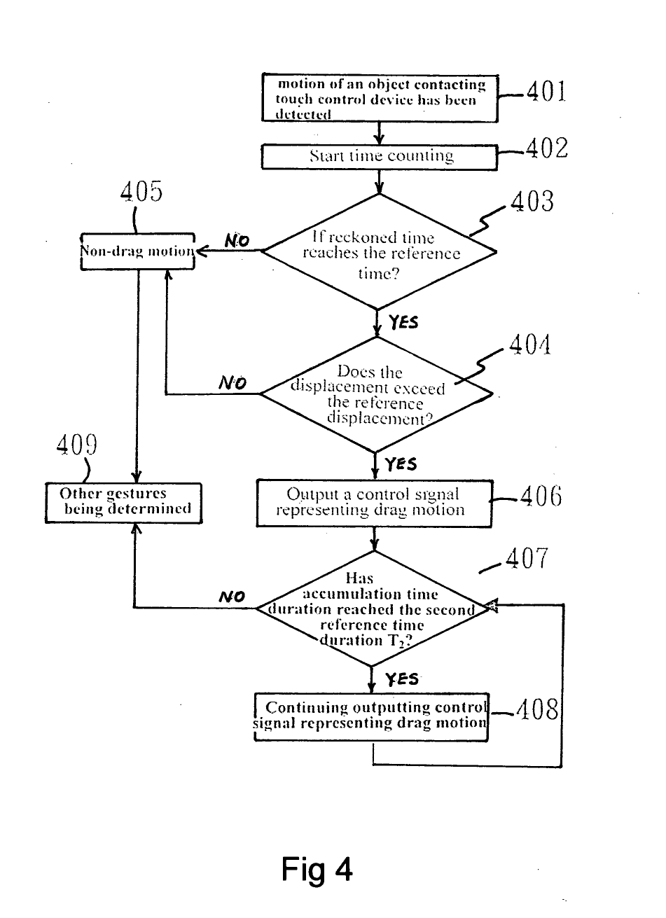

FIG. 4 is a flow chart illustrating steps of a touch control method for a drag according to the present invention;

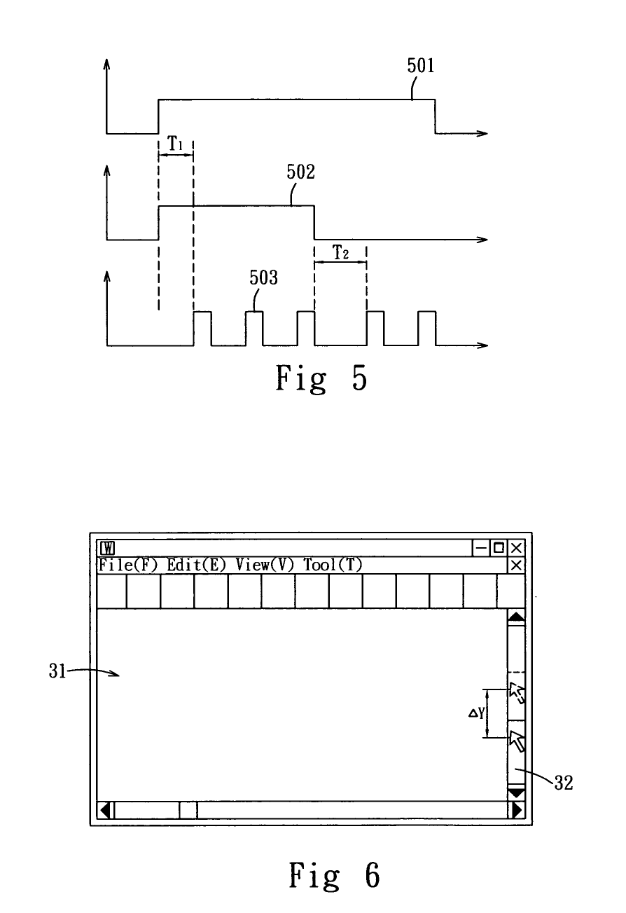

FIG. 5 is a wave curve illustrating the embodiment generating touch signal, displacement signal and control signal while the touch device is pressed; and

FIG. 6 is a plan view illustrating the touch control method for a drag according to the present invention actuating the pointer to move position of the first scroll bar so as to scroll the scroll bar.

### DETAILED DESCRIPTION OF THE PEFERRED EMBODIMENT

Referring to FIG. 3, the control module 13 of the present invention in a preferred embodiment thereof is set up in a touch control device 1 and electrically connected to a touch pad 10 and a main unit 3. The control module 13 is electrically connected to the touch pad 10 via an X-direction processing unit 11 and a Y-direction processing unit 12. The touch pad 10 can be capacitance type, resistance type, inductance, surface sound wave type, supersonic type or optical type.

The touch pad 10 in the present embodiment is taken the capacitance type as an example. Change of the capacitance at the spot of the finger 2 touching the touch pad 10, that is, at the moment of the finger 2 touching the touch pad 10, a contact capacitance can be generated due to the surface of the touch pad 10 being an inductance matrix. The X-direction processing unit 11 and the Y-direction processing unit 12 can trace the path of contact capacitance continuously and the operation unit 131 in the control module 13 can assign X, Y coordinate positional parameter and figure out X, Y direction movements ΔX A Y. In the mean time, the operation unit 131 can measure different pressure changes while the finger 2 touching the touch pad 10 and output touch signals 501 corresponding to the different pressure changes.

Each of the touch signals 501 starts while the touch pad 10 is touched initially and ends while the touched pad 10 is detached finally. The operation unit 131 sends the X-direction displacement ΔX, Y-direction displacement ΔY and the touch signals 501 to a gesture unit 132 and the gesture unit 132 determines what type of touch done by the finger 2 based on values of the X-direction displacement, the Y-direction displacement and the touch signals 501. The touch in the embodiment is drag gesture and the control signal 503 corresponding to the gesture is transmitted to the main unit for further use via a transition.

Referring to FIGS. 3, 4 and 5, first of all, the touch control method of drag according to the present invention as shown in steps 401 and 402 has the gesture unit 132 detecting and starting time counting and keeps detecting and recording time duration of the finger 2 staying on the touch pad 10 once the finger 2 touches the touch pad 10. The positive margin of the touch signal 501 (lower reference position is changed to higher reference position) shown in FIG. 5 means the motion of touch is generated.

As done in step 403, a first reference time T1 is defined in the gesture unit 132. If the gesture 132 determines time duration of the finger 2 staying on the touch pad exceeding the first reference time T1, that is, if the motion of touch on the touch pad 10 exceeds the first reference time T1 and the displacement 502 created by the finger 2 on the touch pad 10 is detected greater than a reference displacement as shown in step 404, the touch can be determined as a drag gesture. If steps 403 and 404 are not satisfied, the touch gesture can be determined as non-drag gesture and the non-drag gesture is further to be identified what the movement actually is as it is done in steps 405 and 409.

If the requirement of step 403, which is the time duration of the finger staying on the touch pad 10 exceeds the first reference time T1, and requirement of step 404, which is the displacement 502 created by the finger on the touch pad 10 being detected greater than a reference displacement, are satisfied, step 406 is executed continuously to output a control signal 503 representing the single tap gesture as shown in FIG. 5. The control signal 503 is output to the main unit 3 after being generated from occurring the drag gesture and lapsing the first reference time T1 and the control signal at the present time is a series of pulse signals.

A second reference time T₂ is defined in the gesture unit 132 too as shown in step 407. The finger 2 stays unmoved and keeps contact with the touch pad 10 and step 408 is executed after time duration of the finger 2 keeping staying on the touch pad 10 exceeding the second reference time T₂. The touch signal 503 is kept to output to the main unit 3 via the transmission interface 14 till the finger 2 is detached from the touch pad. FIG. 5 shows the control signal 503 is stopped outputting the control signal 503 at the negative margin of the touch signal 501 wave, which is a temporary state from high reference position changing to low reference position.

Referring to FIGS. 3, 5 and 6, a preferred embodiment of the touch control method for a drag is illustrated. Taking the first scroll bar 32 of a window page 31 being scrolled a distance ΔY as an example, it is necessary to drag the finger 2 on the touch pad 10 a small distance and the touch signal 501 corresponding to the drag gesture is generated to pass the first reference time T₁ before the control signal 503 is created. The displacement 502 of the finger 2 is determined exceeding the reference displacement and the control signal 503 is output. Afterward, the control signal 503 is kept to output for being used by the main unit even if the finger 2 stays still on the touch pad 10 and keeps contact with the touch pad 10. That is, the moving distance ΔY of the first scroll bar 92 depends on time duration of the drag gesture staying on the touch pad 10 and the user does not have to move the finger 2 unceasingly in order to accumulate considerable displacement for the first scroll bar 92 being able to wind a longer distance.

It is appreciated that the touch control method for a drag according to the present invention is to identify the motion of drag executed on the touch device 1 by the finger 2 by way of the control module 13 of the touch device 1 with control signal 503 is generated corresponding to the drag for being used by the main unit 3 for performing subsequent control function. A first reference time T₁ is defined in the control module 13 and the control module 13 is mainly to detect occurrence of the drag generated during the finger moving on the touch device 1 and start counting time at the same time. Then, the control module 13 determines time of the finger 2 staying contact with the touch device 1 exceeding the first reference time T₁ and outputs a control signal 503 representing the drag motion for being used by the main unit 3. When the finger 2 keeps staying on the touch device 1 for a time duration exceeding the second reference time T₂, the control signal 503 is kept outputting to the main unit 3 till the finger 2 detaching from the touch device 1 so that less effort is needed by the user.

While the invention has been described with referencing to the preferred embodiments thereof it is to be understood that modifications or variations may be easily made without departing from the spirit of this invention, which is defined by the appended claims.

What is claimed is:

1. A touch control method for a drag gesture, which identifies a motion of the drag gesture executed on the touch device by an object by way of a control module of the touch device with control signal being generated corresponding to the drag gesture for being used by an main unit as subsequent control function with a first reference time being defined in the control module, comprising following steps:
A) detecting occurrence of the drag generated during the object moving on the touch device and starting counting time at the same time;
B) determining time of the object staying on the touch device and continuing step (C) in case of the staying time being exceeding the first reference time and the object keeping moving a small distance on the touch device;
C) outputting a control signal representing the motion of drag gesture for being used by the main unit; and
D) keeping outputting the control signal to the main unit during the object stopping moving and keeping contacting with the touch device and stopping outputting the control signal to the main unit once the object detaches from the touch device.

2. The touch control method for a drag gesture as defined in claim 1, wherein a reference displacement is defined in the control module and a displacement signal created by the object on the touch device is detected in step B) and the control signal keeps outputting in step D) in case of the displacement of the object exceeding the reference displacement.

3. The touch control method for a drag gesture as defined in claim 1, wherein a second reference time is defined in the control module and the control signal keeps outputting the control signal in step D) for being used by the main unit during the object stopping moving and keeping contacting with the touch device.

4. A control module, which is used for identifying a motion of drag gesture executed on a touch device by an object with control signal being generated corresponding to the drag gesture for being used by an main unit for performing subsequent control function, comprising:
an operation unit, generating a touch signal corresponding to every occurrence of the object being on the touch device and the touch signal being generated at initiation of the occurrence and terminated at end of the occurrence; and
a gesture unit, being connected to the operation unit and the main unit for receiving the touch signal, figuring out time duration of all the occurrence for identifying what motion of the object is and defining a first reference time therein;
wherein, the gesture unit determines time of the object staying on the touch device being exceeding the first reference time and outputs a control signal representing the motion of drag for being used by the main unit; and keeping outputting the control signal to the main unit during the object stopping moving and keeping contacting with the touch device and stopping outputting the control signal to the main unit once the object detaches from the touch device.

5. The control module as defined in claim 4, wherein a reference displacement is defined in the gesture unit and a displacement signal created by the object on the touch device is detected with the gesture unit and the control signal keeps outputting in case of the displacement of the object exceeding the reference displacement.

6. The control module as defined in claim 4, wherein a second reference time is defined in the gesture unit and the gesture unit keeps outputting the control signal for being used by the main unit during the object stopping moving and keeping contacting with the touch device.
